(19) United States
(12) Patent Application Publication
(10) Pub. No.: US 2004/0048363 A1
(43) Pub. Date: Mar. 11, 2004

(54) Mechanical composting

(75) Inventors: Paul Brown, Auckland (NZ); Graham Fairlie Willson, Nelson (NZ)

Correspondence Address: MERCHANT & GOULD PC, P.O. BOX 2903, MINNEAPOLIS, MN, 55402-0903, US

(73) Assignee: WILLSON BROWN ASSOCIATES LIMITED, Auckland (NZ)

(21) Appl. No.: 10/639,947

(22) Filed: Aug. 12, 2003

Related U.S. Application Data
(63) Continuation of application No. 09/463,148, filed on Jan. 18, 2000, now abandoned.
Application No. 09/463,148 is a 371 of international application No. PCT/NZ98/00107, filed on Jul. 20, 1998.

(30) Foreign Application Priority Data
Jul. 18, 1997 (NZ) 328373

(51) Int. Cl. C05F 11/08

(52) U.S. Cl. 435/290.4; 71/9

(57) ABSTRACT

A composting system and method incorporating a vertical insulated composting tower with one or more compartments. The base of each compartment being fitted with a plenum and grate through which air is self induced and output is regularly removed. The method of composting biodegradable waste material utilises a plug flow principle including inducing low air flow rates through a compost pile using column energy. The method utilises high temperature pyro/thermopylic micro-organism activity in the compost pile and retaining pile energy above stoichometric levels by controlling the induced air flow. Evolved gas extraction is utilised in the compost pile and constant biofilm is maintained by combined cycle anaerobic/aerobic operation.

### FIELD OF THE INVENTION

The invention relates to improved composting and particularly to an improved mechanical composting machine or system.

### BACKGROUND TO THE INVENTION

At present biomass and, in particular food waste, wood waste, wood chips, sewage sludge and even some hazardous wastes and other materials are difficult to handle particularly in bulk.

A number of composting systems are currently available for handling this type of material, however most of these are costly and produce odour, which means that the machines must be located in the countryside, away from urban areas.

Composting of biomass has been practised for thousands of years in various forms. Some composting is natural, as occurs in the humification of material decaying by biological action in natural environments. Mankind has made many attempts to enhance and speed up this process using manually assembled heaps of organic matter and, more recently, mechanical devices. This has arisen from the centralisation of populations and the urban concentration of organic wastes from farm produce generally destined for landfill or sewage ponds. This is opposed to the more recent need to reduce landfill volumes because of their cost of establishment and operation and remediation of sewage ponds after their useful life has ended or urban encroachment has made them unpopular.

Recycling organic matter as compost is an important feature of a sustainable future for the planet. Whatever form of fertigation used, organic matter provides essential nutrient holding capacity as it is broken down by soil organisms and this is a feature of all natural and undisturbed ecosystems in their cycles of growth, death and decay.

It is a feature of currently mechanised composting that the materials to be composted are agitated and a large amount of air, and therefore energy, is consumed in these processes. The number of current Patents and prior art are too numerous to detail but we refer to an important compilation of composting processes by Robert T. Haug. “The Practical Handbook of Compost Engineering”, Lewis Publishers 1993, ISBN # 0-87371-373-7. In this work can be found a complete guide to the science and mechanics of composting including accelerated mechanical systems.

An object of the invention is therefore to provide a low cost composting system suitable for a range of biomass and further, usable as a biofiltration system.

Further objects and advantages of the invention will become apparent from the following descriptions which are given by way of example only.

### SUMMARY OF THE INVENTION

According to the invention there is provided a composting system incorporating a vertical insulated composting tower with one or more compartments, the base of each compartment being fitted with a plenum and grate through which air is self induced and output is regularly removed.

According to another aspect of the invention there is provided a method of composting biodegradable waste material utilising a plug flow principle including:

inducing low air flow rates through a compost pile using column energy;

utilising high temperature pyro/thermopylic micro-organism activity in the compost pile;

retaining pile energy above stoichometric levels by controlling the induced air flow;

utilising evolved gas extraction in the compost pile;

maintaining constant biofilm maintenance by combined cycle anaerobic/aerobic operation; and

removing the biomass material at regular intervals.

Operation of the composting system is continuous and operates on a plug flow principle using controlled shrinkage of biomass materials during their descent through the vertical chamber such that the effects of pressure on the walls of the chamber means that straight sided walls can be used instead of negatively inclined walls as is commonally known in the art and this simplifies construction methods and reduces costs.

The system is hereinafter referred to as a VCU or Vertical Composting Unit.

A second chamber if included can be used for compost maturation and operates in the same manner as the first chamber or, with modular configuration, many individual units can be run in parallel with one feed system.

The base of each compartment is fitted with a plenum and grate system to control air injection and removal of daily output.

Retained pile energy (7.8 G Joules in a 65 m3 VCU) induces air intake above stoichometric levels. A naturally induced excess air rate and evolved gas is controlled by a fan with integral condenser/scrubber for condensate removal and odour control assurance wherever this might be required or mandated by legal requirements.

The continuous-flow vertical composting tower with the insulated thermic pile is advantageously held clear of the ground, freely allowing air induction through the base of the tower, at rates close to the metabolic requirement of the bacteria in the pile, (the stoichiometrically determined oxygen requirement). The tower can be mounted on a plinth or open ended supporting structure, or over an over cavity to achieve this.

The VCU is weather sealed and vermin proof. Low output gas rates reduce scrubber size and cost and increases odour removal efficiency. Odour levels in tests are typically 1-2DT (Dilutions to Threshold) in the stack.

The biomass material requires no agitation, considerably reducing odour potential. Harnessing the lowest air rates in any modern in-vessel system known to the applicants, the VCU promotes high activity of pyrohpilic and thermophilic bacteria and fungi with both aerobic and anaerobic activity occurring simultaneously. The normally smelly gases produced by anaerobic activity are used as food by the high temperature thermophylic and pyrophylic bacteria in the upper zones thus allowing the VCU to filter itself of odours.

The VCU allows for the maintenance of an active moisture bound biofilm from input to output (typically 45-50% w/w) which prevents the possibility of pyrolysis and encourages microbe activity. This makes it especially efficient for processing green wastes combined with food wastes or sewage sludge.

The term “biofilm” as used herein means a thin film of water coating a discrete medium. Organic molecules in gas phase are adsorbed to the medium via the biofilm in which micro-organisms can live and consume the organic molecules in a process called “biofiltration”.

Low air flow reduces the cooling effect of incoming air in the bottom layers giving high efficiency for effective working heights.

High induced air rates commonly used render the bottom levels of a vertical thermic pile ineffective thus adding to the height of the column for productive outputs. High induced air rates further increase the velocity of the gases through the column which leads to the entrainment and emission of bioaerosol particulates and smelly off-gas.

A second chamber (larger installations) is designed for compost maturation and operates on the same principles as the first chamber. Being modular, the system can be run so that one chamber feeds another for purposes of compost maturation. This method may be required on difficult combinations of biomass inputs or in cases of soil remediation. Such slow cycles become split between two VCU's in series to avoid excessive compaction of material.

A gated walking floor passes material down from processing in a controlled daily cycle.

The composting system is continuous giving a daily cycle of input and output activities for staff (2 staff up to 40 m3/D output). The VCU produces compost ready for use in 14 days but can be used as an accelerator (7-10 days) where windrow and subsequent pile turning are viable (80-200 m3/D with present designs).

The major advantage of the VCU is the ability to site the system closer to urban areas reducing collection and disposal costs and enhancing sales of finished products. It also enables the use of corporate, commercial and institutional units on-site.

The VCU uses the “insulated” pile energy to “induce draft” to the “plug flow” thermic pile column. In larger sizes the pile energy amounts to several thousand gigajoules. The heat energy is enough to induce the “appropriate draft” via the inlet manifold, (controlled at “app. Draft plus 3-7% average”). The VCU principle is to extract only the evolved gas from the chamber processes, along with the small amount of naturally induced excess air.

Tests by the New South Wales Environmental Protection Authority show 3-7% excess air without the fan operating.

The applicants test results have shown that there are advantages in allowing anaerobic pockets of activity to develop during shrinkage/compaction processes in the vertical pile. This provides extra food sources for aerobic bacteria capable of adsorbing this “food” in the gas phase or as dissolved in the biofilm. Particular gases formed by mesophilic bacteria and anaerobes are H₂S and CH₄ (hydrogen sulphide and methane) which are gases that normally lead to composting systems smelling and causing nuisance.

Furthermore, condensation on the inside of the vessel roof drops back into the composting biomass sustaining an active biofilm within the composting matrix. While rendering an output of higher moisture content than conventional systems, this biofilm serves two important functions. Firstly it allows an active moisture/solids interface for bacteria and fungi, including anaerobic bacteria, down to the outlet. Secondly it allows an active moisture/gas-flow interface for those aerobic bacteria as mentioned above which obtain their food either in a “gas phase” at the surface of this biofilm or as dissolved within it. This action renders the process virtually completely self-filtering in respect of odours.

Conventional processes try to keep temperatures at under 65-70° C., using large volumes of air. This cools the microbial processes, retarding the beneficial high temperature micro-organisms and produces large amounts of off-gas from intermediate anaerobic reactions. It is this action which makes odour clean up issues much larger and harder to control. The introduction of large amounts of excess air renders a vertical in-vessel composting system inefficient in its lower column section while requiring large amounts of energy.

The applicants computer model (Table 1.) predicts accurately the energy process and the amount of air required. This has been measured on a prototype unit by the New South Wales EPA.

Further aspects of the invention which should be considered in all its novel aspects will become apparent form the following description.

### DESCRIPTION OF THE DRAWINGS

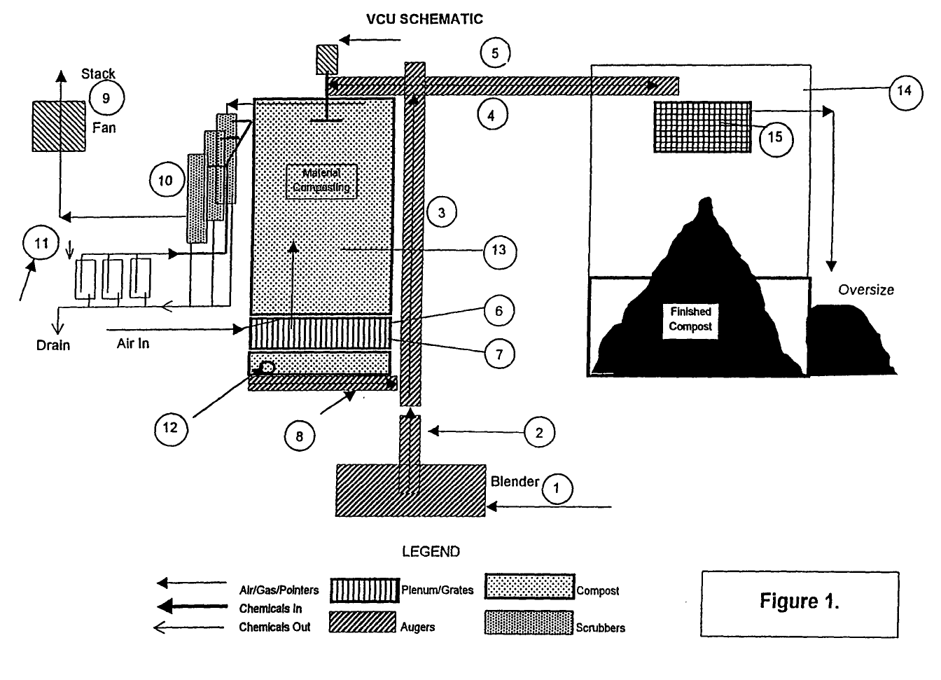

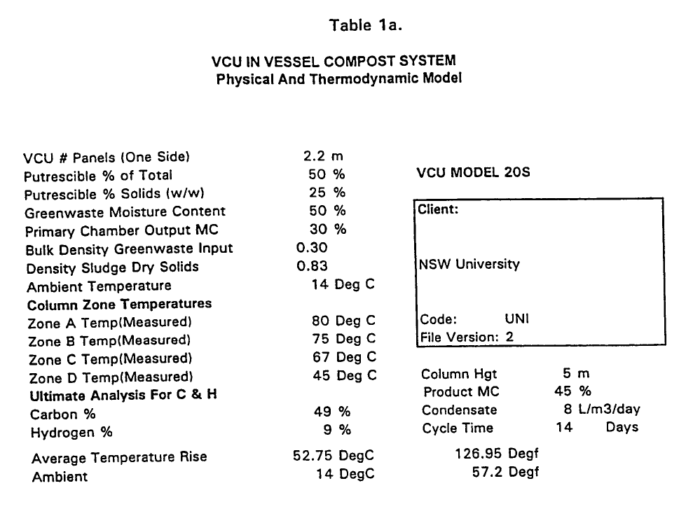

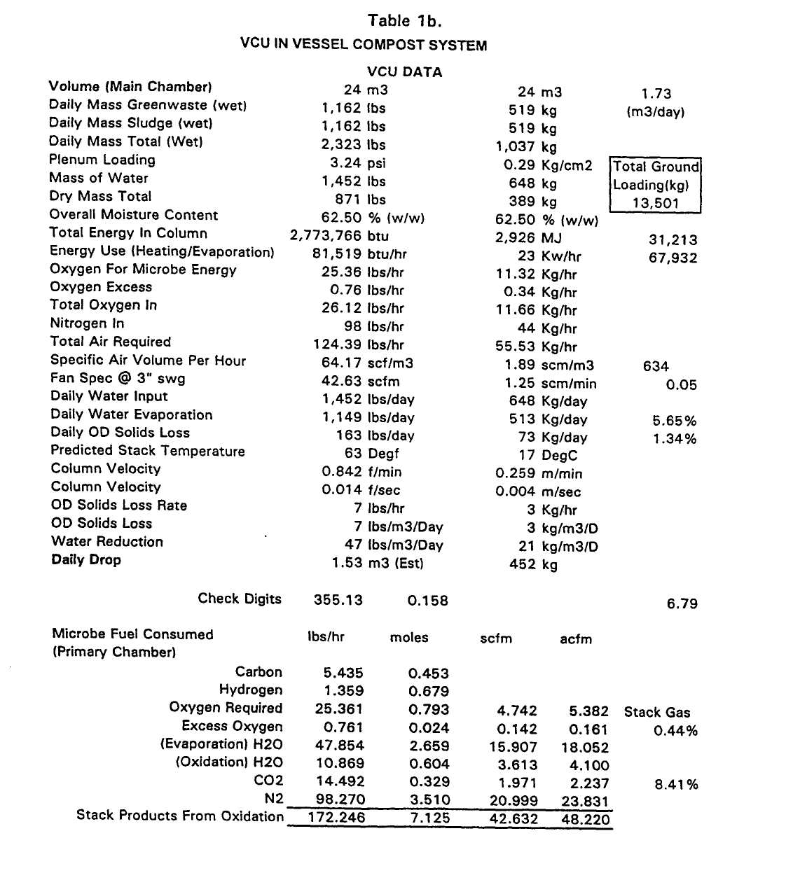

The following description will be with reference to a test compost unit an example of which is shown schematically in the accompanying drawing (FIG. 1).

### DESCRIPTION OF PREFERRED EXAMPLES

The specifications for such a unit (FIG. 1) are set out below:

Typical Commercial Specifications: (Smaller Domestic and Institutional Units not Listed)

| | |
|---|---|
| Sizes: | Daily production rates (m3) of: 0.2, 1.0, 5.0, 25, 50, 100 |
| | Accelerated production rates (m3) of: 0.5, 2.0, 10, 50, 200 |
| Chamber | 5, 20, 50, 250, 500, 1000 |
| Sizes: | |
| Air Use: | Typically 1.25 scm/min (42 scfm) |
| Power | Air: 10 watts/m3 |
| Usage: | Feeding/Shredder: 950 watts/m3 |
| | Controls: 5 watts/m3 |
| Feed | Materials to be processed are placed into a blender (1) to |
| System: | be mixed together with any additives. Blended material is |
| | then sent by the stuffing auger (2) to vertical (3) and |
| | transverse (4) augers. Input is distributed evenly by |
| | rotating disk (5). Automatic level control allows enough |
| | space to empty the feed system. The feed hopper is closed |
| | off after filling to maintain negative pressure throughout the |
| | system and avoid residual odours. A small batch of fresh |
| | green waste can be run through the system to scarify and |
| | clean out the blender and auger tubes. |
| Inputs: | Food waste, sewage sludge, some hazardous wastes, with |
| | bulking agent (shredded green waste or wood chips) to a |
| | maximum of 85% food waste/sludge w/w. Moisture |
| | content range 60% to 80%. Humic acid 60 ml/m3 with |
| | Calcium Ammonium Nitrate at 150 gm/m3, variable |
| | depending on percentage of food waste. Gypsum at |
| | 150 gm/m3. Additives vary according to feed stock |
| | analysis. Magnesium Sulphate (Kieserite) is sometimes |
| | recommended. |
| Extration | Oscillating hydraulically operated grates (6) above plenums |
| Systems: | (7) which open for discharge into storage bin (not shown) |
| | underneath. A larger single chamber accelerator unit can |
| | have wheel loader access bins underneath. Larger systems |
| | can also have a floor sweep auger (12) and return auger (8) |
| | for discharge to a screening and oversize return |
| | arrangment, and a screening and oversize return |
| | arrangement, and finished compost storage as shown |
| | in FIG 1. |
| Cycle Times: | 7 to 28 days depending on fineness of product required and |
| | method of maturation. |
| Outputs: | Self-mulching compost (unscreened) or graded in separate |
| | screening plant. Oversize can be used as additional bulking |
| | agent in recycle or pulverised. Compost yield at 10 mm is |
| | generally volume 85% with shredded green waste, +10 mm |
| | wood chip bulking agents are recycled after |
| | screening. A system with a second maturation chamber |
| | gives product ready for use without windrow curing. |
| | In FIG. 1 is shown a bunker (14). The bunker may be |
| | covered on three sides with a roof. The bunker (14) may |
| | include a screen and optional grinder (15). |
| Operating | Primary Chamber (12) |
| Temps: | Top: 80-85° C. |
| | Middle: 60-70° C. |
| | Bottom: 45-50° C. |
| Filtration: | Largely self-filtering through compost base material |
| | combined with very low air rates. Odour potential |
| | is 1-2 DT at the fan outlet (9) when operating on food |
| | waste/green waste. (Gaussian Dispersion Distance Model) - |
| | result is therefore well below human detection thresholds at |
| | a distance of 20 metres. |
| | Outlet gas is optionally passed through a triple scrubber |
| | (10) containing NaOH, NaOCl, CH3COOH and water. |
| | Scrubbers (10) can be standard packed spray towers. |
| | Scrubber fluids are pump recirculated with tanks (11) |
| | refilled as activity is neutralised by carry over. Economic |
| | tank sizes give approximately 12-18 months activity and |
| | are sealed and locked. Disposal is environmentally benign |
| | since chemicals are used to neutralise each other to pH 7. |
| | This cost effective gas scrubbing system needs only to be |
| | used on potentially aggressive bioremediation processing. |
| | Normally a simple condensate filter is used. This is because |
| | the stack gases are so small compared with other systems |
| | that they have a very large dilution factor on release to |
| | atmosphere. Should any operational errors produce smelly |
| | gases, the effect would be rapidly dispersed into ambient |
| | air without noticeable effects to those close by. |
| Condensates: | Test traps are located in the condensers. Condensate is |
| | clear and almost tasteless at pH 5 (average) with no |
| | pathogens or nitrates and suitable for irrigation or storm |
| | water disposal (Cawthron Institute Tests and NSW EPA |
| | Tests). |
| Leachates: | None unless input moisture exceeds 80%. Leachate pH |
| | 6.5 with some brown humus solids and some nitrate. |
| | Biological oxygen demand (BOD) is negligible. Leachates |
| | are easily controlled by input management but can be |
| | contained for recycle if they occur. |
| Pathogens: | Assumed to be pathogen free and pathogen resistant at 14 |
| | day minimum composting period because of composting |
| | conditions. Pathogen screens by the Cawthron Institute |
| | and NSW EPA confirm zero pathogens. |
| Toxicity | 90% root length (AS3743). |
| Index: | |
| Germination: | 99% (AS3743) (applies to system with maturation chamber |
| | producing finished compost). |
| Weed | Zero survival after 14 days. |
| Seeds: | |
| Post | Ready to use in 14 to 28 days depending on unit location |
| Curing | and maturation requirements. The VCU can be used for |
| Time: | accelerated breakdown of food waste and sludge (7-10 |
| | days) but a large area may be required for windrowing for |
| | post curing. This type of use of the system means the |
| | operation can not be located close to urban areas. |
| Staffing: | Two persons up to 500 m3 model. |

The applicants have found in operating the test unit (Typical of FIG. 1) that a very large volume of food scraps or sludge can be mixed with shredded green waste. Food slops bring the moisture content of the mix to an ideal level (green waste is generally less than 50% moisture and food wastes up to 90%). Large food scraps such as potatoes, pumpkins, onions etc. need to be shredded. This drastically reduces bulk, increases surface area, and allows a mix to contain up to 80% food wastes/sludge by weight without greatly increasing overall volume. This is because the mashed up food waste occupies most of what would otherwise be void space between shredded green waste particles. Higher than 80% moisture can sometimes lead to a small amount of leachate (pH 6.5) in the bottom plenum 8 and a slightly damper product. This moisture flashes off very quickly when the material is withdrawn (45-55° C.) and has a natural earthy odour. Even with food scraps there is little ammonium nitrate or sulphurous odour detectable in the compost. By controlling inputs and additives, the main cation predominating is calcium without detectable losses of nitrogen. Nutrient analysis (AS3743) is high for all nutrients and trace element balance but depends on the combination and analysis of material fed into the system.

The fungal growth is prolific in the bottom zones because of the moist conditions provided. The applicants have identified both iron and sulphur converting fungi. The applicants believe, and will test further, the premise that extended high temperature zones exhibit favourable processing conditions and that there may be some pyrophyllic decomposer organisms which have not yet been identified. These research projects will be conducted at the University of NSW.

Initial discussion with Cawthron Institute in respect of testing these fungi indicate that the VCU does produce an enhanced environment for pyro/thermophyles, hitherto not typed, which aggressively attack ligno-cellulosic structures in these ideal conditions provided by the VCU.

A computer model has been used and set out on attached drawing labelled Table 1 is the physical thermodynamic model for the example of a single chamber module version VCU shown in FIG. 1.

Advantages of the present invention are as follows:

Enclosed insulated vertical pile;

Plug flow principles;

Insulated pile energy;

Column pile energy induced draft,

Low air rates;

High temperatures—utilising pyro/thermophylic micro-organism activities

Evolved gas extraction only;

Constant biofilm maintenance;

Low energy demand/consumption;

Small footprint/land use to production capacity;

Combined cycle anaerobic/aerobic operation;

Negligible odour and emission production;

Modular design—several chambers with one feed/discharge system.

Key Principles embodied in the invention:

Low air rates, high temperatures;

Low power consumption;

Low operating costs;

Small footprint and land use;

Negligible odour (urban locations possible);

Column energy air induction;

Fan removal of evolved gases only;

Modular design: one feed system for several units.

Where in the description a particular mechanical or other integer has been described it is envisaged that their alternatives are included as if they were individually setforth.

Particular examples of the invention have been described and it is envisaged that improvements and modifications can take place without departing from the scope thereof.

Thus by this invention there is provided an improved mechanical composting unit.

1. A composting system incorporating a vertical insulated composting tower with one or more chambers, the base of each chamber being fitted with a plenum and grate through which air is induced and output is daily removed.

2. A composting system as claimed in claim 1 wherein operation is continuous and operates on a plug flow principle using controlled shrinkage of biomass materials during their descent through the vertical chamber.

3. A composting system as claimed in claim 1 or claim 2 wherein a second chamber if included is used for compost maturation and operates in the same manner as the first chamber.

4. A composting system as claimed in claim 3 which is of modular configuration with units which can be run in parallel or series with one feed system.

5. A composting system as claimed in any one of the preceding claims wherein the base of each chamber is fitted with a plenum and grate system to control air injection and removal of daily output.

6. A composting system as claimed in any one of the preceding claims wherein retained pile energy induces air intake above stoichometric levels.

7. A composting system as claimed in any one of the preceding claims which a naturally induced excess air rate and evolved gas is controlled by a fan with integral condenser/scrubber for condensate removal and odour control assurance.

8. A composting system as claimed in any one of the preceding claims wherein the insulated composting tower incorporating the thermic pile is held clear of the ground, freely allowing air induction through the base of the tower at rates close to the metabolic requirement of the bacteria in the pile.

9. A composting system as claimed in claim 8 wherein the composting tower is mounted on a plinth, open-ended supporting structure or over an open cavity.

10. A composting system as claimed in any one of the preceding claims which is weather sealed and vermin proof.

11. A composting system as claimed in any one of the claims 3 to 10 which is modular so that one chamber feeds another for purposes of compost maturation.

10. A composting system as claimed in any one of the preceding claims which includes a gated walking floor or other discharge mechanism which passes material down from processing in a controlled daily cycle.

13. A method of composting biodegradable waste material utilising a plug flow principle including:
inducing low air flow rates through a compost pile using column energy;
utilising high temperature pyro/thermopylic micro-organism activity in the compost pile;
retaining pile energy above stoichometric levels by controlling the induced air flow;
utilising evolved gas extraction in the compost pile;
maintaining constant biofilm maintenance by combined anaerobic/aerobic operation; and
removing the biomass material at regular intervals.

14. A method as claimed in claim 13 which includes retaining a naturally induced excess air rate and evolved gas by controlling by a fan with integral condenser/scrubber for condensate removal and odour control assurance.

15. A method as claimed in claim 13 or claim 14 wherein the biomass material requires no agitation.

16. A method as claimed in any one of claims 13 to 15 including the step of maintaining an active moisture bound biofilm from input to output (typically 45-50% w/w) which prevents the possibility of pyrolysis and encourages microbe activity.

17. A method as claimed in any one of claims 13 to 15 wherein the low air flow reduces the cooling effect of incoming air in the bottom layers giving high efficiency for effective working heights.

18. A method as claimed in any one of claims 13 to 17 and substantially as hereinbefore described.

19. A composting system as claimed in claim 1 and substantially as hereinbefore described with reference to the accompanying drawings.
